(19) United States
(12) Patent Application Publication
(10) Pub. No.: US 2006/0202621 A1
(43) Pub. Date: Sep. 14, 2006

(54) Plasma display panel (PDP)

(76) Inventor: Hun-Suk Yoo, Suwon-si (KR)

Correspondence Address: Robert E. Bushnell, Suite 300, 1522 K Street, N.W., Washington, DC, 20005, US

(21) Appl. No.: 11/358,316

(22) Filed: Feb. 22, 2006

(30) Foreign Application Priority Data
Mar. 9, 2005 (KR) 10-2005-0019547

(51) Int. Cl. H01J 17/49

(52) U.S. Cl. 313/583; 313/582

(57) ABSTRACT

A Plasma Display Panel (PDP) with an improved structure of electrodes that enhances discharge efficiency and luminous efficiency includes: front and rear substrates facing each other; barrier ribs partitioning a plurality of discharge cells in a space between the front and rear substrates; address electrodes extending along a first direction between the front and rear substrates; first and second electrodes extending along a second direction crossing the first direction corresponding to each of the discharge cells, and phosphor layers contained within the discharge cells. The first and second electrodes include metal electrodes extending in the second direction, protrusion electrodes projecting toward a center of each of the discharge cells from the metal electrodes, and fence electrodes surrounding the protrusion electrodes.

### CLAIM OF PRIORITY

This application makes reference to, incorporates the same herein, and claims all benefits accruing under 35 U.S.C. § 119 from an application earlier filed in the Korean Intellectual Property Office on 9 Mar. 2005 and there duly assigned Ser. No. 10-2005-0019547.

### BACKGROUND OF THE INVENTION

1. Field of the Invention

The present invention relates to a Plasma Display Panel (PDP), and more particularly to a PDP with an improved electrode structure, which enhances discharge efficiency and luminous efficiency.

2. Description of the Related Art

A Plasma Display Panel (hereinafter referred to as a PDP) is a display apparatus using plasma discharge. In other words, vacuum ultraviolet light emitted by the plasma discharge excites phosphor layers, which in turn emit visible rays. The PDP has been highlighted as a next generation large-sized flat display because it has characteristics of a large screen and high definition.

A typical PDP has a three-electrode surface discharge structure. A pair of electrodes is formed on a front substrate while facing each other on the same plane. Address electrodes are formed on a rear substrate spaced apart from the front substrate. Thus, a plurality of discharge cells are formed at the location where the pair of electrodes and the address electrodes intersect each other. The plurality of discharge cells are defined by barrier ribs which are formed between the front and rear substrates. Phosphor layers are formed in the discharge cells, and a discharge gas is injected therein.

Millions of unit discharge cells are arranged in a matrix within the PDP. The discharge cells arranged in a matrix are driven simultaneously using memory characteristics.

In more detail, discharge cells to be turned on are selected using memory characteristics of wall charges, and sustain discharges are generated in the selected discharge cells.

In other words, in the case of selecting the discharge cells, scan pulse voltages are supplied to scan electrodes of the pair of electrodes arranged on the front substrate, and predetermined voltages are supplied to address electrodes. Accordingly, a weak discharge occurs between the scan and address electrodes and wall charges are accumulated inside the discharge cells, thereby selecting the discharge cells to be turned on. Subsequently, a discharge firing voltage is supplied to the pair of electrodes arranged on the front substrate, thereby causing the sustain discharge to occur in the selected discharge cells.

In the PDP structured and operated as described above, several steps are involved between when power is input to the PDP to when visible light rays are emitted therefrom. Therefore, there is a problem in that the luminous efficiency (the ratio of brightness to power consumption) is very low because the energy conversion efficiency in each step is very low.

Furthermore, the pair of electrodes arranged on the front substrate includes a transparent electrode formed over the discharge cells and a metal electrode. The metal electrode compensates for a voltage drop due to the high resistance of the transparent electrode. However, because the transparent electrode has a low conductivity, the structure of the electrodes require a high discharge current. This results in an increase in the consumed power and a decrease in the luminous brightness.

### SUMMARY OF THE INVENTION

The present invention has been made in an effort to provide a PDP with an improved electrode structure that enhances the discharge efficiency and luminous efficiency thereof.

An exemplary Plasma Display Panel (PDP) according to an embodiment of the present invention includes: front and rear substrates facing each other; barrier ribs partitioning a plurality of discharge cells in a space between the front and rear substrates phosphor layers contained within the discharge cells; address electrodes extending along a first direction between the front and rear substrates; and first and second electrodes extending along a second direction crossing the first direction and corresponding to each of the discharge cells, the first and second electrodes including: metal electrodes extending in the second direction; protrusion electrodes projecting toward a center of each of the discharge cells from the metal electrodes; and fence electrodes surrounding the protrusion electrodes.

The fence electrodes preferably extend from the metal electrodes. The fence electrodes preferably include: first line portions extending in the first direction from the metal electrodes and arranged between adjacent protrusion electrodes in the second direction; and second line portions extending in the second direction, the second line portions connecting the first line portions to each other.

The first line portions are preferably arranged at boundaries between adjacent discharge cells in the second direction. The second line portions of the first electrodes and the second line portions of the second electrodes are preferably arranged opposite to each other with the center of each of the discharge cells therebetween. A distance between the second line portions of the first electrodes and the second line portions of the second electrodes is preferably less than the distance between the protrusion electrodes of the first electrodes and the protrusion electrodes of the second electrodes.

The barrier ribs preferably include longitudinal barrier ribs extending in the first direction, and the first line portions are preferably arranged along and over the longitudinal barrier ribs. The barrier ribs preferably include longitudinal barrier ribs extending in the first direction and transverse barrier ribs extending in the second direction, and the metal electrodes are preferably arranged adjacent to the transverse barrier ribs.

The fence electrodes are preferably arranged apart from the protrusion electrodes. The protrusion electrodes and the fence electrodes each preferably include a transparent conductive material. The protrusion electrodes and the fence electrodes each alternatively preferably include an opaque metal material.

Widths of the protrusion electrodes measured in the second direction are preferably equal to widths of the metal electrodes. The protrusion electrodes preferably each include an opaque metal material, and the fence electrodes preferably each include a transparent conductive material.

The protrusion electrodes preferably include first protrusions projecting toward the center of each of the discharge cells from the metal electrodes, and second protrusions surrounding the first protrusions. The second protrusions are preferably arranged between the first protrusions and the fence electrodes. The second protrusions are preferably respectively arranged apart from the first protrusions and the fence electrodes.

Widths of the protrusion electrodes adjacent to the metal electrodes are preferably less than widths of the protrusion electrodes adjacent to the center of each of the discharge cells, the widths being measured in the second direction.

The PDP further preferably includes recesses arranged in the protrusion electrodes, the recesses being arranged adjacent to the metal electrodes.

### BRIEF DESCRIPTION OF THE DRAWINGS

A more complete appreciation of the present invention and many of the attendant advantages thereof will be readily apparent as the present invention becomes better understood by reference to the following detailed description when considered in conjunction with the accompanying drawings in which like reference symbols indicate the same or similar components, wherein:

FIG. 1 is a partially exploded perspective view of a Plasma Display Panel (PDP) according to the first exemplary embodiment of the present invention.

FIG. 2 is a partial plan view of the PDP of FIG. 1.

FIG. 3 is cross-sectional view taken along the line III-III of FIG. 2.

FIG. 4 is a partially exploded perspective view of a scan electrode according to the first exemplary embodiment of the present invention.

FIG. 5 is a partially exploded perspective view of a scan electrode according to the second exemplary embodiment of the present invention.

FIG. 6 is a partially exploded perspective view of a scan electrode according to the third exemplary embodiment of the present invention.

FIG. 7 is a partial plan view of a PDP according to the fourth exemplary embodiment of the present invention.

FIG. 8 is a graph of the distribution of the brightness in a unit discharge cell.

### DETAILED DESCRIPTION OF THE INVENTION

Embodiments of the present invention are described hereinafter in detail with reference to the accompanying drawings. The present invention can, however, be embodied in different forms and should not be construed as being limited to the exemplary embodiments set forth herein.

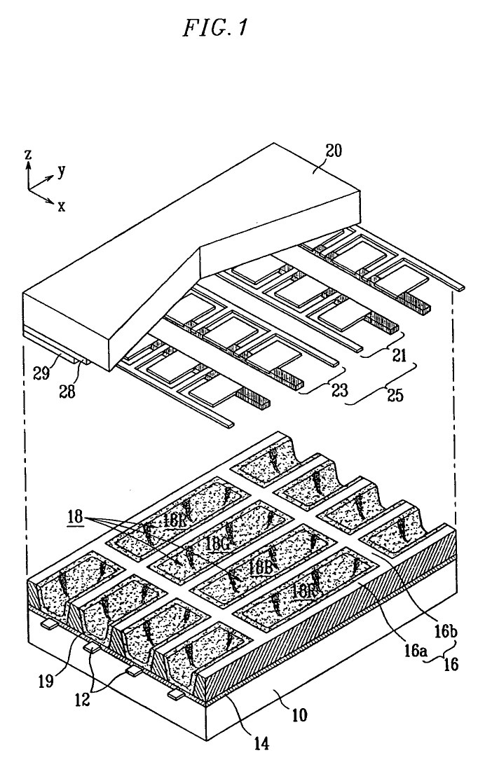

FIG. 1 is a partially exploded perspective view showing a Plasma Display Panel (hereinafter, referred to as a PDP) according to the first exemplary embodiment of the present invention.

Referring to FIG. 1, in the PDP of the present exemplary embodiment, a rear substrate 10 and a front substrate 20 are arranged opposite to each other with a predetermined distance therebetween. Color-based discharge cells 18 (18R, 18G, and 18B) are partitioned using barrier ribs 16, at a space between the rear and front substrates I0 and 20. Furthermore, phosphor layers 19, which are excited to emit visible light, are formed in each of the discharge cells 18. In more detail, the phosphor layers 19 are formed on side surfaces of the barrier ribs, and on bottom surfaces of the discharge cells 18. The discharge cells 18 are filled with a discharge gas to generate a plasma discharge, and the discharge gas includes a mixture of xenon (Xe) and neon (Ne).

The front substrate 20 is formed of a transparent material such as glass. Accordingly, the front substrate 20 transmits the visible light to thereby display an image.

Address electrodes 12 are formed to extend in a first direction (y axis direction in FIG. 1) on the inner surface of the rear substrate 10 opposite to the front substrate 20. The address electrodes 12 are arranged to be spaced apart from each other while corresponding to each of the discharge cells 18. In addition, the address electrodes 12 are covered with dielectric layers 14. The barrier ribs 16 have a predetermined pattern and are formed on the dielectric layers 14.

The barrier ribs 16 partition the discharge cells 18, i.e., discharge spaces where the discharge is performed. This prevents cross-talk between adjacent discharge cells 18. The barrier ribs 16 include longitudinal barrier ribs 16a and transverse barrier ribs 16b. The longitudinal barrier ribs 16a extend in a first direction (y-axis direction FIG. 1) and are spaced apart from each other with the address electrodes 12 therebetween, and the transverse barrier ribs 16b are formed to extend in a second direction (x axis direction in FIG. 1) crossing the first direction. The longitudinal barrier ribs 16a and the transverse barrier ribs 16b are in one plane. In this way, discharge cells 18 with a closed structure are formed.

The aforementioned structure of the barrier ribs is a preferable exemplary embodiment, and accordingly it is possible that variously shaped barrier ribs such as stripe-type barrier ribs can be arranged to be in parallel with the address electrodes 12.

Ultraviolet light emitted by the plasma discharge excites the phosphor layers 19 that are formed inside the discharge cells 18, thereby causing visible light to be emitted. As shown in FIG. 1, the phosphor layers 19 are formed on side surfaces of the barrier ribs 16, and on bottom surfaces of the discharge cells 18 defined by the barrier ribs 16. The phosphor layers 19 can each be formed using any one of red (R), green (G), and blue (B) phosphors to represent color. Accordingly, the phosphor layers 19 may be classified into red, green, and blue phosphor layers 18R, 18G, and 18B. As described above, the discharge gas, such as the mixture of neon (Ne) and xenon (Xe), is injected into the discharge cells 18 where the phosphor layers 19 are formed.

Display electrodes 25 are formed to extend in the second direction (x axis direction in FIG. 1) on an inner surface of the front substrate 20 opposite to the rear substrate 10, corresponding to each of the discharge cells 18. Each display electrode 25 is functionally comprised of a first electrode (hereinafter referred to as a sustain electrode) 21 and a second electrode (hereinafter referred to as a scan electrode) 23. The scan electrode 23 interacts with an address electrode 12 to select a discharge cell 18 to be turned on, and the sustain electrode 21 interacts with the scan electrode 23 to generate a sustain discharge at the selected discharge cell 18.

The display electrodes 25 that are comprised of the scan and sustain electrodes 23 and 21 each include metal, protrusion, and fence electrodes. A detailed description of the display electrodes 25 will be given later.

The display electrodes 25 are covered with dielectric layers 28, which are formed of dielectric materials such as PbO, B₂O₃, or SiO₂. The dielectric layers 28 prevent charged particles from directly colliding with and damaging the display electrodes 25 during the discharge, and collect the charged particles.

Protective layers 29, which are formed of magnesium oxide (MgO), are formed on the dielectric layers 28. The protective layers 29 prevent charged particles from directly colliding with and damaging the dielectric layers 28 during the discharge. Furthermore, when the charged particles collide with the protective layers 29, secondary electrons are emitted, thereby improving discharge efficiency.

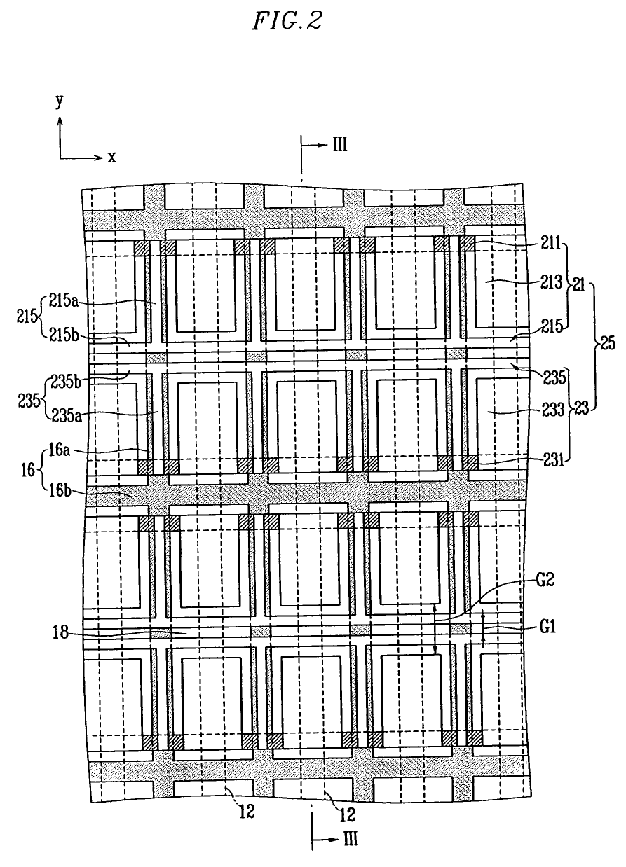

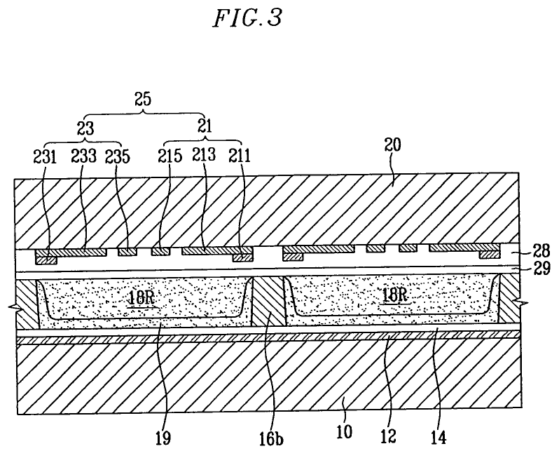

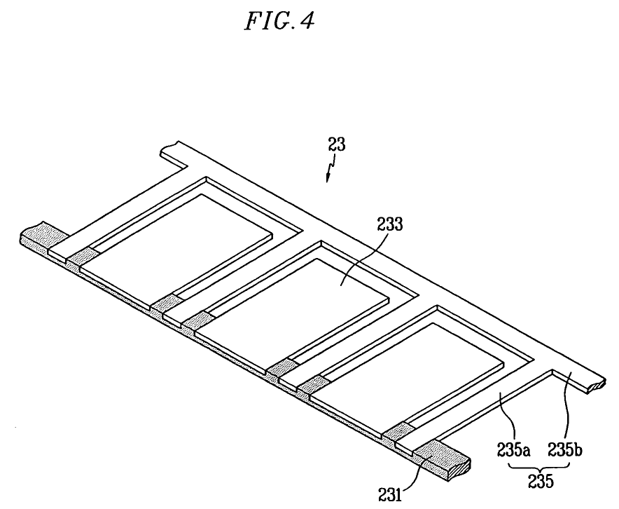

FIG. 2 is a partial plan view of the PDP of FIG. 1, FIG. 3 is cross-sectional view taken along the line III-III of FIG. 2, and FIG. 4 is a partially exploded perspective view of a scan electrode according to the first exemplary embodiment of the present invention.

The structure of the discharge cells according to the present embodiment is explained below with reference to FIGS. 2 to 4.

Referring to FIGS. 2 and 3, a plurality of transverse barrier ribs 16b are formed to extend along the second direction (x axis direction in FIG. 2). The transverse barrier ribs 16b are formed over the entire surface of the dielectric layers 14 of the rear substrate 14 while maintaining a constant interval between adjacent transverse barrier ribs 16b.

Furthermore, the longitudinal barrier ribs 16a are formed in the first direction crossing the transverse barrier ribs 16b. Accordingly, the discharge cells 18 are partitioned into a lattice shape.

The discharge cells 18 are formed in a rectangular shape in which the longitudinal length is greater than the transverse length. A pixel is configured to have red, green, and blue discharge cells. A pixel is a base unit for displaying an image. Display electrodes 25 are formed on the inner surface of the front substrate 20 opposite to the rear substrate 10. The display electrodes 25 extend in the second direction (x axis direction in FIG. 2), and the scan and sustain electrodes 23 and 21 of the display electrodes 25 are arranged opposite to each other up and down inside the discharge cells.

The scan electrodes 23 and the sustain electrodes 21 have the same shape in the present embodiment. Therefore, the present embodiment is explained below with respect to the scan electrodes 23 and not the sustain electrodes 21.

In the present embodiment, the scan electrodes 23 include metal electrodes 231, protrusion electrodes 233, and fence electrodes 235.

The metal electrodes 231 are formed to extend in the second direction. Specifically, the metal electrodes 231 are arranged adjacent to the transverse barrier ribs 16b within the discharge cells. The metal electrodes 231 are formed as a thin film. The metal electrodes 231 and 211 of the scan and sustain electrodes 23 and 21 are respectively formed adjacent to the edges (x axis direction in FIG. 2) of each of the discharge cells. In addition, the metal electrodes 231 and 211 are formed of a highly conductive material (Ag, Cr, etc.) to compensate for the high resistance of the protrusion electrodes 233 and 213 and the fence electrodes 235 and 215. The protrusion electrodes 233 are formed to project from the metal electrodes 231 toward the center of the discharge cells. Furthermore, because the protrusion electrodes 233 have a predetermined surface area, wall charges can be accumulated at locations corresponding to the protrusion electrodes 233. Accordingly, the protrusion electrodes 233 play a substantial role in generating a main discharge within the discharge cells. The protrusion electrodes 233 are formed of a conductive transparent material such as Indium Tin Oxide (ITO) so as to obtain a suitable aperture ratio.

The fence electrodes 235 are formed within the discharge cells 18 to surround the protrusion electrodes 233. The fence electrodes 235 are arranged to be spaced apart from the protrusion electrodes 233, and are formed of a conductive transparent material.

Specifically, the fence electrodes include first line portions 235a and second line portions 235b. The first line portions 235a are formed to extend along the first direction from the metal electrodes 231 between the adjacent protrusion electrodes 233 in the second direction, and the second line portions 235b are formed to extend in the second direction while connecting the first line portions 235a to each other. More specifically, the first line portions 215a and 235a are arranged at the boundaries between adjacent discharge cells 18 in the second direction. Furthermore, the second line portions 235b of the scan electrodes 23 and the second line portions 215b of the sustain electrodes 21 are arranged opposite to each other with the center of each of the discharge cells 18 therebetween, thereby forming a discharge gap.

In other words, a distance GI between the second line portions 235b of the scan electrodes 23 and the second line portions 215b of the sustain electrodes 21 is shorter than a distance G2 between the protrusion electrodes 233 of the scan electrodes 23 and the protrusion electrodes 213 of the sustain electrodes 21. Accordingly, an initial discharge occurs between the second line portions 235b and 215b in the initial stage of discharge. Subsequently, the initial discharge spreads to a long gap discharge between the protrusion electrodes 233 and 213 by the priming effect, and the long gap discharge diffuses into a surface discharge using the entire discharge space.

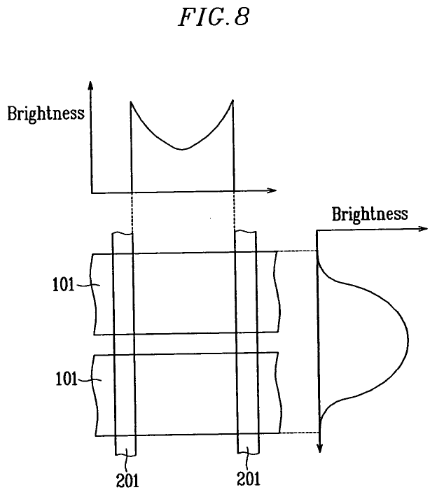

The first line portions 235a are formed in thin films of strips, and are formed along and over the longitudinal barrier ribs 16a. FIG. 8 is a graph of the distribution of brightness in the unit discharge cell in a PDP. Referring to FIG. 8, the brightness has a peak value at the locations adjacent to the discharge gap between electrodes 101 and at the locations adjacent to the barrier ribs 201. Accordingly, the brightness can be significantly enhanced because the first line portions 235a in the present embodiment are formed along and over the longitudinal barrier ribs 16a. In addition, the aperture ratio and the transmittance can be enhanced.

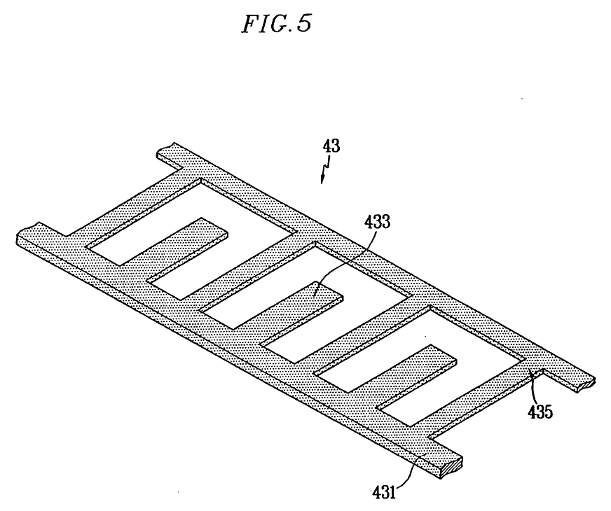

FIG. 5 is a partially exploded perspective view of a scan electrode according to the second exemplary embodiment of the present invention.

Referring to FIG. 5, protrusion electrodes 433 of scan electrodes 43 according to the present embodiment are formed of an opaque metal material. Furthermore, fence electrodes 435 surrounding the protrusion electrodes 433 of the scan electrodes 43 are formed of the opaque metal material. Accordingly, the power consumption can be lowered because the entirety of each scan electrode 43 is formed of the opaque metal materials.

Furthermore, the widths of the protrusion electrodes 433 measured in the second direction are substantially the same as widths of the metal electrodes 431. By this configuration, there is an advantage in that the aperture ratio does not decrease while lowering the power consumption.

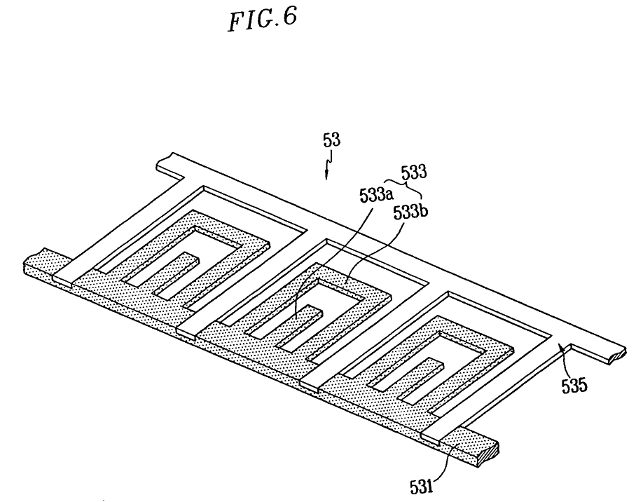

FIG. 6 is a partially exploded perspective view of a scan electrode according to the third exemplary embodiment of the present invention.

Referring to FIG.6, scan electrodes 53 according to the present embodiment include metal electrodes 531, protrusion electrodes 533 formed of an opaque metal material, and fence electrodes 535 formed of a transparent conductive material. Furthermore, the protrusion electrodes 533 include first protrusions 533a and second protrusions 533b. The first protrusions 533a are formed to project toward the center of each of the discharge cells from the metal electrodes 531. The second protrusions 533b are formed to surround the first protrusions 533a, and are arranged between the first protrusions 533a and the fence electrodes 535. Furthermore, the second protrusions 533b are spaced apart from the first protrusions 533a and the fence electrodes 535 by a predetermined distance.

This configuration provides an advantage in that the transmittance does not decrease while lowering the power consumption.

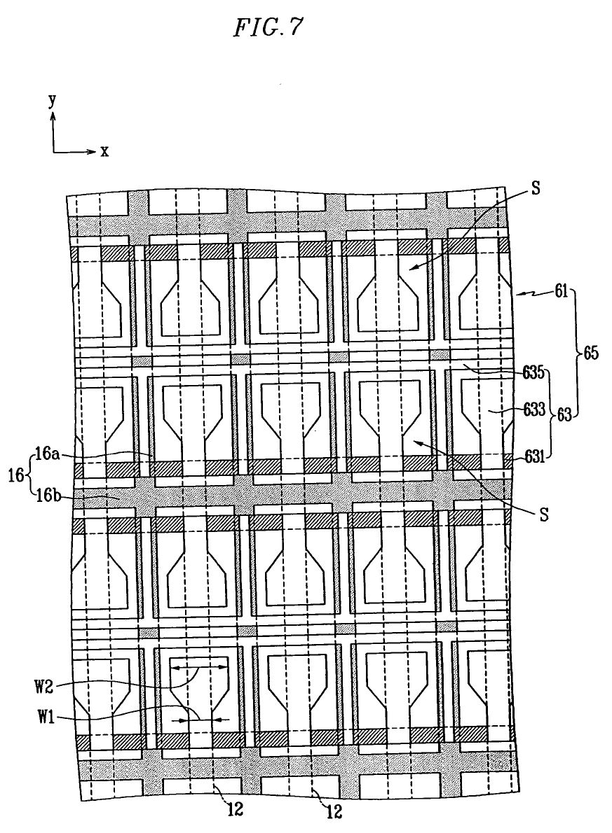

FIG. 7 is a partial plan view of a PDP according to the fourth exemplary embodiment of the present invention.

Referring to FIG. 7, recesses S are formed in sustain electrodes 61 and scan electrodes 63 of the display electrodes 65 according to the present embodiment. Specifically, the widths W1 of protrusion electrodes 633 adjacent to metal electrodes 631 are less than widths W2 of the protrusion electrodes 633 adjacent to the center of each of the discharge cells near the fence electrodes 635, the widths being measured in the second direction (x axis direction in FIG.7). Basically, a weak discharge occurs at the location where the protrusion electrodes 633 meet the metal electrodes 631. Accordingly, because the recesses S are formed in the protrusion electrodes 633 at locations where the protrusion electrodes 633 meet the metal electrodes 631, the discharge efficiency can be enhanced while lowering the power consumption.

The discharge efficiency and luminous efficiency of a PDP can be enhanced because the display electrodes according to the present invention have the protrusion electrodes and the fence electrodes surrounding the protrusion electrodes.

Furthermore, according to the display electrodes of the present invention, the aperture ratio and transmittance can be enhanced even more because the area of transparent conductive electrodes is decreased.

While the present invention has been described in connection with what is presently considered to be practical exemplary embodiments, it is to be understood that the present invention is not limited to the disclosed embodiments, but, on the contrary, is intended to cover various modifications and equivalent arrangements included within the spirit and scope of the appended claims.

What is claimed is:

1. A Plasma Display Panel (PDP), comprising:
front and rear substrates facing each other;
barrier ribs partitioning a plurality of discharge cells in a space between the front and rear substrates;
phosphor layers contained within the discharge cells;
address electrodes extending along a first direction between the front and rear substrates; and
first and second electrodes extending along a second direction crossing the first direction and corresponding to each of the discharge cells, the first and second electrodes including: metal electrodes extending in the second direction; protrusion electrodes projecting toward a center of each of the discharge cells from the metal electrodes; and fence electrodes surrounding the protrusion electrodes.

2. The PDP of claim 1, wherein the fence electrodes extend from the metal electrodes.

3. The PDP of claim 2, wherein the fence electrodes comprise:
first line portions extending in the first direction from the metal electrodes and arranged between adjacent protrusion electrodes in the second direction; and
second line portions extending in the second direction, the second line portions connecting the first line portions to each other.

4. The PDP of claim 3, wherein the first line portions are arranged at boundaries between adjacent discharge cells in the second direction.

5. The PDP of claim 3, wherein the second line portions of the first electrodes and the second line portions of the second electrodes are arranged opposite to each other with the center of each of the discharge cells therebetween.

6. The PDP of claim 5, wherein a distance between the second line portions of the first electrodes and the second line portions of the second electrodes is less than the distance between the protrusion electrodes of the first electrodes and the protrusion electrodes of the second electrodes.

7. The PDP of claim 2, wherein the barrier ribs comprise longitudinal barrier ribs extending in the first direction, and wherein the first line portions are arranged along and over the longitudinal barrier ribs.

8. The PDP of claim 2, wherein the barrier ribs comprise longitudinal barrier ribs extending in the first direction and transverse barrier ribs extending in the second direction, and wherein the metal electrodes are arranged adjacent to the transverse barrier ribs.

9. The PDP of claim 1, wherein the fence electrodes are arranged apart from the protrusion electrodes.

10. The PDP of claim 1, wherein the protrusion electrodes and the fence electrodes each comprise a transparent conductive material.

11. The PDP of claim 1, wherein the protrusion electrodes and the fence electrodes each comprise an opaque metal material.

12. The PDP of claim 11, wherein widths of the protrusion electrodes measured in the second direction are equal to widths of the metal electrodes.

13. The PDP of claim 1, wherein the protrusion electrodes each comprise an opaque metal material, and wherein the fence electrodes each comprise a transparent conductive material.

14. The PDP of claim 13, wherein the protrusion electrodes comprise first protrusions projecting toward the center of each of the discharge cells from the metal electrodes, and second protrusions surrounding the first protrusions.

15. The PDP of claim 14, wherein the second protrusions are arranged between the first protrusions and the fence electrodes.

16. The PDP of claim 15, wherein the second protrusions are respectively arranged apart from the first protrusions and the fence electrodes.

17. The PDP of claim 1, wherein widths of the protrusion electrodes adjacent to the metal electrodes are less than widths of the protrusion electrodes adjacent to the center of each of the discharge cells, the widths being measured in the second direction.

18. The PDP of claim 17, further comprising recesses arranged in the protrusion electrodes, the recesses being arranged adjacent to the metal electrodes.
